(19) United States
(12) Patent Application Publication
(10) Pub. No.: US 2007/0241098 A1
(43) Pub. Date: Oct. 18, 2007

(54) Clock Timer For A Spa System

(76) Inventors: Patrick Graham, Watertown, CT (US); Andrew Tournas, Bethany, CT (US)

Correspondence Address: GORDON & JACOBSON, P.C., 60 LONG RIDGE ROAD, SUITE 407, STAMFORD, CT, 06902, US

(21) Appl. No.: 11/733,285

(22) Filed: Apr. 10, 2007

Related U.S. Application Data
(63) Continuation-in-part of application No. 11/379,859, filed on Apr. 24, 2006.
(60) Provisional application No. 60/596,648, filed on Oct. 10, 2005.

(51) Int. Cl. H05B 1/02

(52) U.S. Cl. 219/492; 4/541.6

(57) ABSTRACT

A spa is provided with a water temperature modification system for heating the water contained in the spa tub. The spa includes a control system that operates with the water temperature modification system to achieve a spa water temperature at a time preset by a user. The control system preferably uses a clock, a temperature measuring device, and a database to preheat the spa water to the set temperature in an efficient manner just prior to the time set by the user.

### CROSS-REFERENCE TO RELATED APPLICATIONS

This application is a continuation-in-part of U.S. Ser. No. 11/379,859, filed Apr. 24, 2006, which claims the benefit of U.S. Provisional App. No. 60/596,648, filed Oct. 10, 2005, both of which are hereby incorporated by reference in their entireties.

### BACKGROUND OF THE INVENTION

1. Field of the Invention

This invention relates broadly to spa and systems for temperature control thereof. More particularly, this invention relates to a spa incorporating a heat pump system to both heat and cool the spa water.

2. State of the Art

Spas, in the form of a hot tub or larger swim spas, are generally heated by electric heaters. An electric heater is employed to heat the water temperature to a temperature as set by a user through a user interface. The interface triggers a controller to operate the heater. After the water temperature reaches the set temperature, the controller stops the electricity supply to the heater. Over time, the water temperature decreases due to heat loss to the ambient through the spa tub insulation material and by direct heat loss at the water surface. When the water temperature reaches a certain temperature below the set temperature, the electric heater again heats the water. Heating via electricity can be very inefficient. For example, the typical electric spa heater requires 5.5 kW, powered at 23 amps which, with the high cost of electrical energy, can be very expensive to run.

In a hot geographical region, it may be beneficial for a spa tub to have cooling capability to cool the water to a set temperature below ambient temperature. One spa that provides such functionality is the Atera Anytemp SpasTM from Four Seasons Home Products, Inc. of Phoenix, Ariz. This spa includes a 4.3 kW electric heater to heat the water and a separate 6000 BTU water chiller to cool the water. Both the electric heater and water chiller are energy inefficient. In addition, this system heats the spa water no faster than a conventional spa heater.

Heat pump systems have been used to heat the water in pools more efficiently than electric heaters. In addition, U.S. Pat. No. 5,509,274 to Lackstrom describes using a heat pump to both heat and cool ambient air in an environment associated with a pool or hot tub heated by the heat pump. However, a heat pump has not been effectively used to both heat and cool the water in a spa tub.

### SUMMARY OF THE INVENTION

It is therefore an object of the invention to provide a spa with a heating and cooling system which is energy efficient in a standard mode of operation.

It is another object of the invention to provide a spa with a heating and cooling system which has a rapid heating mode of operation that is significantly faster than a conventional electric heater.

It is also an object of the invention to provide a spa with a heating and cooling system to provide temperature stabilization capacity.

It is still another object of the invention to provide a spa that has a programmable timer to allow fixing the spa water temperature at a desired time.

In accord with these objects, which will be discussed in detail below, a spa is provided with a heat pump system for both heating and cooling the water contained in the spa tub. The spa includes a tub, a plurality of jets within the tub wall, a suction fitting, associated plumbing, and a water pump to circulate out of the tub through the suction fitting, through the plumbing and back through the jets under pressure back into the tub. As the water is sent to the jets it is moved through a venturi where air from a supply is entrained within the water. A cabinet supports the tub and encloses the workings of the spa.

The heat pump includes a compressor, a water heat exchanger, an expansion device, an ambient heat exchanger, connective plumbing, a four-way valve enabling a preferred reversible operation, and a working fluid (refrigerant) therein. In accord with a preferred aspect of the invention, the heat pump uses the existing water pump of the spa to circulate the water through the water heat exchanger of the heat pump. The heat pump can be operated to raise or decrease the water temperature or maintain water temperature.

It is recognized that the ambient heat exchanger of the heat pump will produce condensate. In distinction from systems that are solely intended to be used outdoors, the removal of condensate from the heat pump is an issue when the spa system of the invention is adapted for indoor use. Without proper removal, such condensate may cause water to runoff into an indoor home space and cause associated wet spots, water damage and/or mold and mildew. In accord with one preferred aspect of the invention, plumbing is provided to couple condensate collection to the venturi at the water jets. Thus, negative pressure created at the venturi during water jet operation causes automatic removal of condensate from the heat pump and provides it into the spa tub.

In accord with another preferred aspect of the invention, the ambient heat exchanger during operation automatically periodically cycles off and on to prevent and/or remove frost build-up on the heat exchange coils thereof.

In accord with a yet another preferred aspect of the invention, components of the heat pump are subject to noise reduction. Such noise reduction may include physical masking by acoustic isolation and/or insulation. Alternatively, the noise reduction may be implemented electronically.

The spa and cabinet together define a space therebetween. In accord with a further preferred aspect of the invention, a diverter is provided which directs air which is most efficient for use to the ambient heat exchanger. For example, air from the space may be pulled when it is warmer than ambient air, and ambient air may be pulled when warmer than air in the space or when pulling air from the space would result in other thermal inefficiencies (e.g., excessive cooling of the spa tub water).

The spa preferably includes an ozonator, which is known in the art to control bacteria and otherwise filter the water. The ozonator requires an infusion of dry air for optimal operation, as dry air accepts more ozone for delivery to the water. In accord with another aspect of the invention, drier air from the cool side of the ambient heat exchanger of the heat pump is drawn off and sent to the ozonator to optimize operation of the ozonator.

In accord with an additional preferred aspect of the invention, the spa also includes a conventional electric heater that can be activated in conjunction with the heat pump to provide a rapid heating mode. Because the water is brought up to the desired temperature more rapidly and then maintained at the desired temperature with the higher efficiency heat pump, overall energy efficiency is increased. In a preferred embodiment, the heater coil of the electrical heater is integrated with the heat pump.

In accord with yet another aspect of the invention, a heat pump and temperature control system can be retrofit to an existing spa such that the heat pump is located outside the cabinet of the spa and plumbing is used to circulate water to the heat pump or refrigerant into the cabinet of the spa.

In accord with still another aspect of the invention, a control system is provided for a spa system such that the user of the spa can program a set time into the control system such that the water in the spa reaches a user specified temperature at the set time.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective of a spa tub system according to the invention, with a portion of the cabinet shown in partial section to reveal components of the water circulation system and water temperature control systems;

FIG. 2 is a schematic of the spa tub, hydrotherapy jet circulation system and water temperature control systems;

FIG. 3 is a schematic of one embodiment of a water temperature control system according to the invention;

FIG. 4 is a schematic of another embodiment of a water temperature control system according to the invention;

FIG. 5 is a schematic of circuit for control of a water temperature control system according to the invention;

FIG. 6 is a schematic of a retrofittable heat pump system according to the invention; and

FIG. 7 is a flowchart of an algorithm for controlling water temperature within a spa tub.

### DETAILED DESCRIPTION OF THE PREFERRED EMBODIMENTS

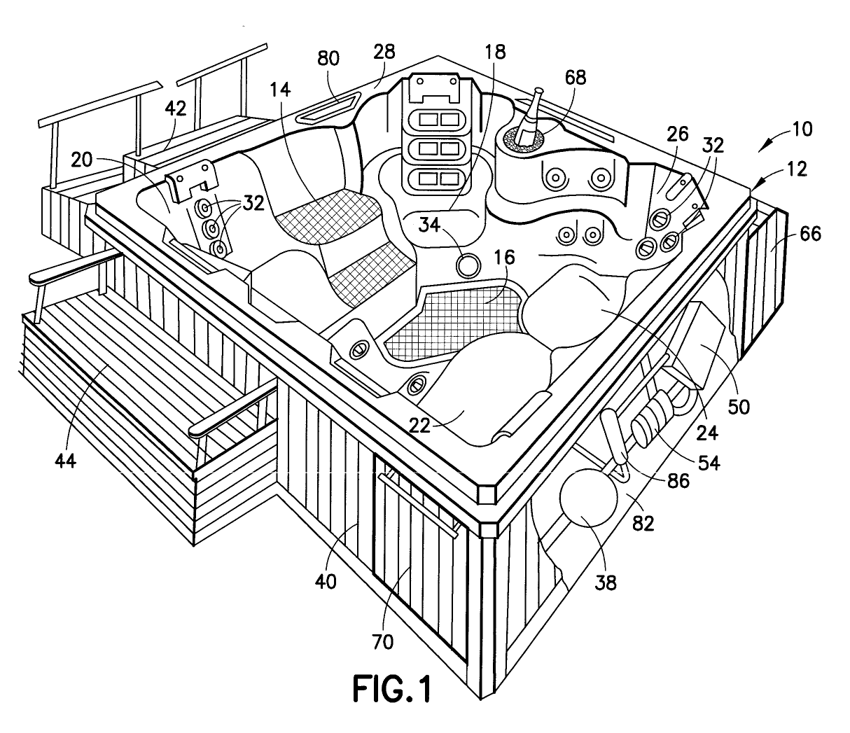

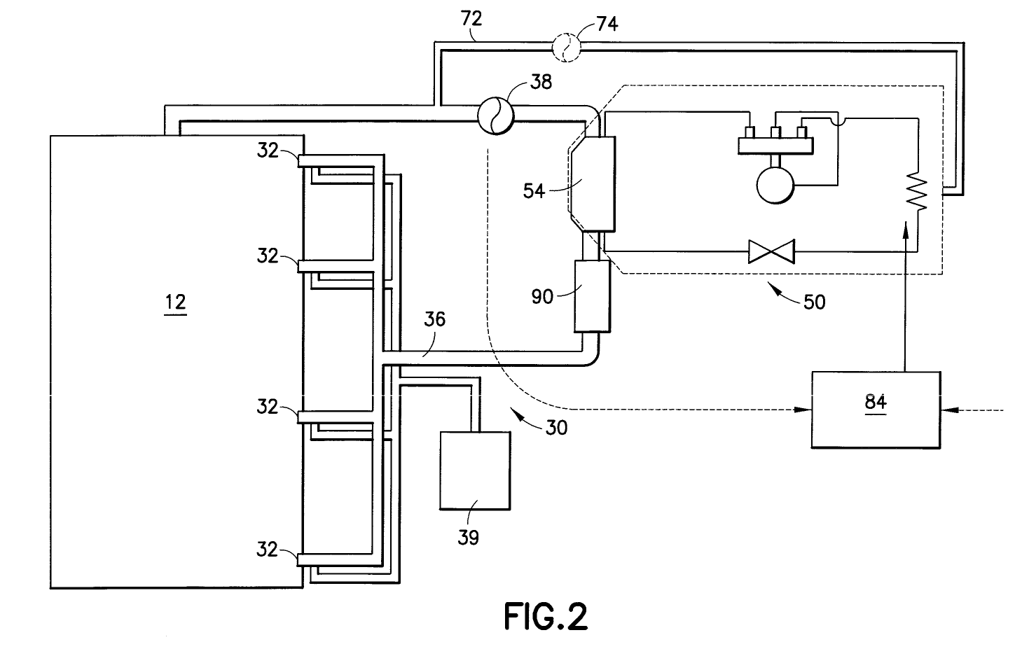

Turning now to FIGS. 1 and 2, a hot tub spa system 10 is shown. The system 10 includes a hot tub 12 formed as a molded shell defining steps 14 into the tub, a floor 16, seating areas 18, 20, 22, 24, 26, and an upper rim 28 among other features. The spa includes a hydrotherapy system 30 comprising a plurality of jet assemblies 32 situated within the shell of the tub 12 at the seating areas 18, 20, 22, 24, 26, a suction fitting 34, associated plumbing 36, and a water pump 38 to circulate water out of the tub through the suction fitting, the plumbing, and back through the jet assemblies 32 under pressure into the tub 12. As the water is sent to the jets 32, it is forced through venturi where air from an air source 39 is entrained within the water such that when the water is ejected by the jet, it is aerated. A cabinet 40 surrounds the tub 12 and encloses the hydrotherapy workings of the spa. The spa may also be associated with stairs 42 leading into the spa from an interior floor or exterior ground surface and one or more sitting benches 44, planters, etc.

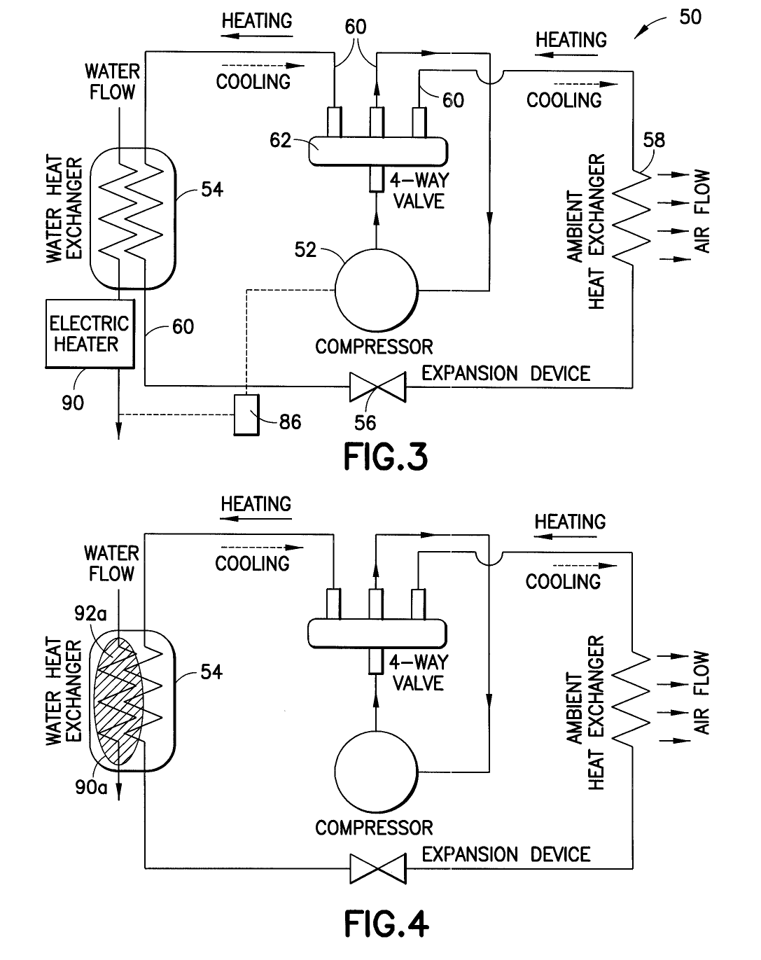

Referring to FIGS. 2 and 3, the spa is provided with a heat pump 50 for heating and cooling the water contained in the spa tub 12. The heat pump 50 includes a compressor 52, a water heat exchanger 54, an expansion device 56, an ambient heat exchanger 58, connective plumbing 60, a four-way valve 62 enabling a preferred reversible operation, and a working fluid (refrigerant) therein. As discussed further below, the water pump 38 for the hydrotherapy system 30 routes tub water through the water side heat exchanger 54 to effect heating or cooling of the spa tub water. Thus, no separate water pump is required to circulate the water through the heat pump 50. The heat pump 50 can be operated to raise or decrease the water temperature or maintain the water temperature at a set temperature.

In a water heating mode, the compressor 52 compresses a working fluid (refrigerant) and discharges the fluid through the four-way valve 62. The working fluid then enters the water heat exchanger 54 and heats the water. Inside the water heat exchanger 54, the working fluid is cooled and condensed. The condensed working fluid expands in the expansion device 56 becoming low temperature and low pressure. The low temperature working fluid enters the ambient heat exchanger 58 absorbing heat from the environment. Inside the ambient heat exchanger 58 the working fluid evaporates using the heat from the environment. The working fluid vapor flow through the four-way valve 62 then enters the compressor 52. In a cooling mode, the working fluid flow direction is reversed by the four-way valve 62 such that heat is absorbed at the water heat exchanger 54 and removed at the ambient heat exchanger 58. The four-way valve 62 is operated by a solenoid, and the flow direction inside the four-way valve 62 is determined by whether or not the solenoid is in an energized state, as set by a controller 102, discussed below with respect to FIG. 5. This four-way valve mechanism allows for easy reversal of the working fluid flow direction when the controller is triggered for switching the modes, as discussed below.

The heat pump 50 is energy efficient relative to a standard electric resistance heater. As a result of the low working fluid temperature at the ambient heat exchanger 58, heat is absorbed from the ambient. This heat is used to evaporate the working fluid. During the evaporation, the energy of the working fluid is increased. The evaporated working fluid is compressed at the compressor 52. During the compression process, the compressor 52 requires external energy (electricity), and this energy is added to the working fluid. The absorbed energy from the ambient and the added energy at the compressor is transferred to the water at the water heat exchanger 54. Typically, the absorbed energy at the ambient heat exchanger 58 is larger than three or four times the required energy for the compressor 52, and this results in a heating system three to four times more efficient than a standard or conventional electric resistance heater for a spa tub. The heat pump is inherently more efficient than a conventional resistance heater because it uses energy only to remove and transport heat from the ambient to the spa water, not create the heat using resistance heating. Since the heat pump removes heat from the ambient for heating, its efficiency depends on the temperature of the surrounding ambient. In hot climates, such as the southern United States, the heat pump can be up to five times more efficient than a resistance heater. In cooler climates, such as the northern United States, the heating efficiency of the heat pump relative to the resistance heater falls to three times more efficient or less. If the heat pump is a ground source version, since the ground temperature stays relatively constant, the efficiencies of the heat pump stay about the same in all parts of the country at about five times more efficient than the resistance heater. By way of example, the heat pump uses 1 kW (110V at 10 amps), whereas the resistance heater uses 5.5 kW (220V at 23 amps).

As an example of external maintenance of heating sources, the heat pump 50 is preferably electrically powered and in a preferred embodiment the ambient heat exchanger 58 is an air heat exchanger. Such air heat exchangers can be mounted internally; i.e.; within the spa tub cabinet 40, or can be mounted externally of the spa tub 12 within a separate housing but coupled to the water heat exchanger 54 within the cabinet 40 and/or other plumbing within the cabinet through appropriate connections. Air heat exchangers are efficient in relatively warmer climates. Alternatively, the ambient heat exchanger can be a ground source heat exchanger which has the advantage of pulling heat from the ground rather than the air and is generally more efficient in all climates, but requires a more extensive installation. The ground source heat exchanger can be mounted directly beneath or adjacent the cabinet or spaced apart therefrom, e.g., in a separate housing. The separate housing for any of the described ambient heat exchangers may be the stairs 42, the benches 44, planters associated with the spa, or other structures.

In addition, cool air from the cold side of the ambient heat exchanger 58 can be piped through an insulated container 66 mounted within or adjacent to the spa tub cabinet which is used as a refrigerator for food or beverage, or can be routed for use as a bottle chiller 62 integrated into the spa tub shell. Warm air from the warm side of the ambient heat exchanger 58 can be piped to a towel warmer 68; i.e. an at least partially enclosed housing including towel hooks or bars, which is integrated into the spa cabinet.

It is recognized that the ambient heat exchanger 58 of the heat pump will produce condensate. In distinction from prior art gas and electric fired heat pump systems that are specifically designed to heat large swimming pools and are solely intended to be used outdoors, the removal of condensate from a heat pump is an issue when the spa system of the invention is adapted for indoor use. Such condensate may cause water to runoff into an indoor home space and cause associated wet spots, water damage and/or mold and mildew, unless properly removed. In accord with one preferred aspect of the invention, the heat pump 50 (or at least ambient heat exchanger 58) is mounted at an angle (e.g., from the spa shell or to a wall of the cabinet) to cause gravity feed drainage of condensate from the unit. The condensate is collected in a reservoir. Plumbing is provided to couple the reservoir to the venturi at the water jets. Then, negative pressure created at the venturi during water jet operation causes the condensate to be sucked from the heat pump 50 and provided into the spa tub. Alternatively, the water pump 54 for the therapeutic jets may be configured with plumbing 72 to pump such collected condensate into the spa tub 12, e.g., via one or more of the jets 32. In yet another alternate embodiment, a separate dedicated pump 74 is provided to remove the condensate and provide it into the spa tub. By removing the condensate from the mechanicals of the heat pump system, indoor use of the system will not result in any water damage from condensate produced by the ambient heat exchanger.

In accord with another preferred aspect of the invention, the ambient heat exchanger 58 automatically cycles off and on periodically during operation. Without such cycling, the coils of the ambient heat exchanger may become built-up with frost as humid air is blown across the cool coils, greatly reducing the efficiency of the system or even causing extended periods of shutdown while the coils are defrosted. Cycling keeps the coils free of frost.

In accord with a yet another preferred aspect of the invention, components of the heat pump 50 are subject to noise reduction so that the noise is masked from persons seated in the spa tub 12 to prevent their disturbance. Such noise reduction may include physical masking by acoustical isolation and/or insulation. For example, the compressor and other components may be acoustically isolated from the spa tub shell 12 and cabinet 40 via an acoustic panels, acoustic thermal batting, acoustic foam, ThinsulateM hydrophobic acoustic insulation, and/or other materials that provide acoustic attenuation. In addition, components of the heat pump 50 may be mounted to the underside of the spa shell and/or within the cabinet using vibration-absorbent coupling elements, including, but not limited to, rubber washers. Alternatively, the noise reduction may be implemented electronically, via an active noise reduction system which generates sound waves out-of-phase with the sound waves (noise) generated by the heat pump 50 and preferably the hydrotherapy jet system 30 as well. Exemplar active noise reduction systems are described in U.S. Pat. Nos. 5,384,853, 5,434,925 and 5,559,893, which are incorporated by reference herein in their entireties. In accord with another preferred aspect of the invention, the user interface 80 for electronically operating the controller 102 of the heating and cooling operations and the water pump 38 for hydrotherapy systems is located along the rim 28 of the spa tub shell at an opposite side of the tub from where the heat pump 50 and water pump 38 are located. Primary users of the hot tub typically sit in seats adjacent the interface 80 for ease of operation of spa tub systems and such seats therefore are at a maximum distance from heat pump components, thereby locating the primary users of the tub and the source of noise generation at maximum distances from each other.

In accord with a further preferred aspect of the invention, the spa tub shell 12 and cabinet 40 together define a space 82 therebetween. Heat is co-generated by the water pump 38 and the compressor 52 of the heat pump 50 and the hot air is collected within the space 82. In a heating mode of operation, the air in the space 82 can be directed by a diverter 84 to ambient heat exchanger when the air in the space is warmer than the ambient air. Then, when ambient air is warmer than air in the space 82 or when pulling air from the space would result in other thermal inefficiencies (e.g., excessive cooling of the spa tub water, as such air operates to insulate the water), the diverter 84 is automatically redirected to pull ambient air.

In addition, such co-generated heat in space 82 can be made available to the air supply 39 for the jets 32 via use of check valves mounted on the jet valve bodies, as disclosed in U.S. Pat. No. 5,850,640 or through an air valve coupled, e.g., via manifold, to the air plumbing through which air is plumbed to the venturis at the jets. Thus the entrained air is more comfortable to the users of the spa.

The spa preferably includes an ozonator 86, which is known in the art to control bacteria and otherwise filter the water. The standard location of the ozonator 86 within the space 82 defined between the spa tub shell and cabinet is particularly humid. However, the ozonator requires an infusion of dry air for optimal operation, as dry air accepts more ozone for delivery to the water. Therefore, in the prior art, operation of an ozonator in a conventional spa tub may be less than optimal. In accord with another aspect of the invention, drier air from the cool side of the ambient heat exchanger 58 of the heat pump is drawn off and sent to the ozonator to optimize operation of the ozonator.

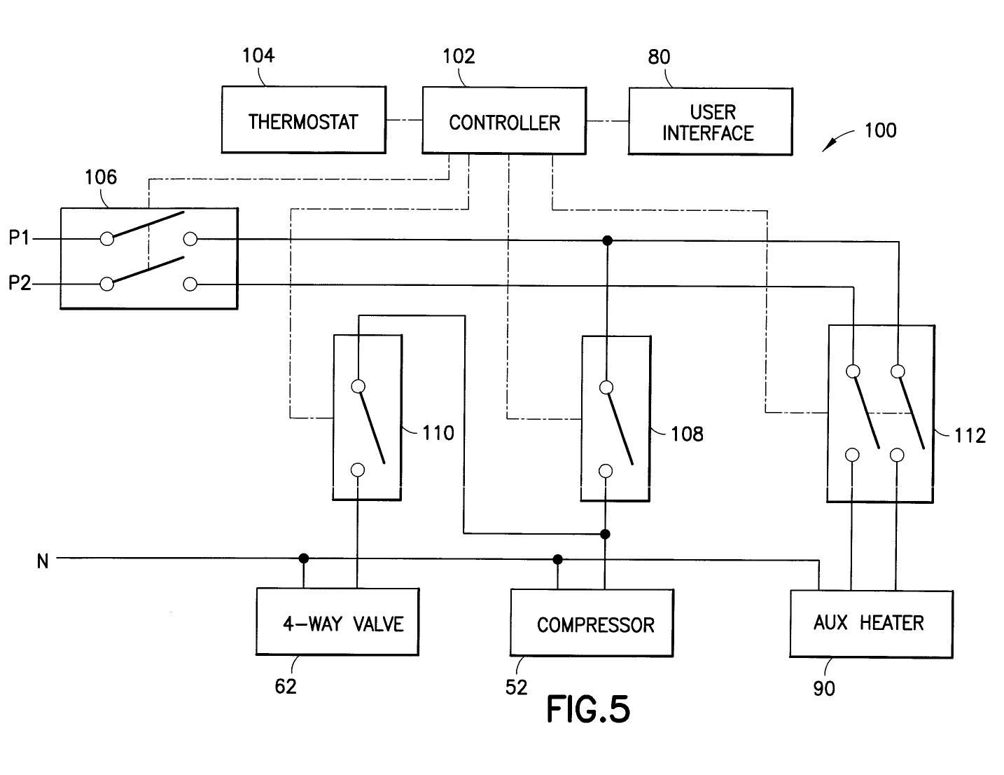

In accord with an additional preferred aspect of the invention, the spa also includes a conventional electric resistance heater 90 that can be activated in conjunction with the heat pump 50 as an auxiliary heater to provide a rapid heating or turbo mode. In turbo mode operation, the heating system uses approximately 6.5 kW of power. Because the water is brought up to the desired temperature more rapidly, the spa tub may be used sooner after activating the controller 102 (FIG. 5) (via the interface 80) to increase the water temperature to the desired higher temperature from the starting temperature. In one embodiment, shown in FIG. 4, a portion of the heat pump water heat exchanger 54 is integrated with the heater coil 92a of the electric resistance heater 90a. In this embodiment, the coils of the water heat exchanger 54 are contained within the heater unit and the resistance heater coils 92a wrapped around the outside of the water heat exchanger 54, or vice versa. Such provides the advantage of both space savings and cost savings. The cost savings can be significant where the shell of the water heat exchanger 54 is an expensive material such as titanium. In this case only one titanium shell would be required. Once at the desired temperature, the electric resistance heater 90a would shut off, allowing the more energy efficient heat pump to maintain the water temperature.

As essentially all spa tub systems currently in service include an electric resistance heater, the heat pump 50 is ideally suited as a retrofit module for placement within spa tubs already including a resistance heater. Such retrofit can be performed by a technician onsite at an install location. The addition of the above described heat pump to a spa tub already including an electric resistance heater provides a cost efficiency way to achieve the benefits discussed herein; i.e., overall energy efficiency, rapid heating mode, and cooling mode.

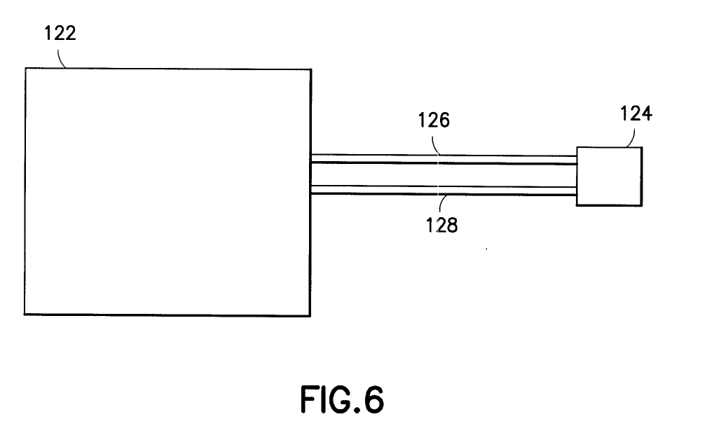

Turning now to FIG. 6, an example of a spa system is shown having an external heat pump 124. Such a system allows a spa system 122 to be retrofit to take advantage of the benefits of the heat pump 124. In these systems, the heat pump 124 can be mounted on the outside of the spa cabinet or located at a distance therefrom.Moreover, external placement of the heat pump 124 allows the heat pump to be built into functional elements adjacent or near the spa for users of the tub to enter/exit the tub or relax outside the tub. By way of example, such functional elements may include one or more of steps, a seat, a bench and/or a planter, which can form a housing for all or portions of the heat pump. The heat pump 124 includes a compressor, a water heat exchanger, an expansion device, an ambient heat exchanger, connective plumbing, a four-way valve, and a working fluid (refrigerant). In one embodiment, the water is circulated out of the tub and cabinet of the spa system 122 through plumbing 126 to the water heat exchanger of the heat pump 124 and back into the cabinet to the plumbing therein to recirculate to the jet assemblies. In an alternative embodiment, the water heat exchanger is provided within the spa tub cabinet and the refrigerant is plumbed through the heat pump 124 through the plumbing 128 to the water heat exchanger within the spa tub cabinet to modify the temperature of the water as necessary.

Turning now to FIG. 5, an exemplar electric circuit 100 for activating various functions of the temperature control system is shown. The circuit 100 is activated via signals from the controller 102, which is triggered by input at the user interface 80 and a thermostat 104. The circuit 100 shown includes four relays (main power relay 106, compressor relay 108, heat/cool mode relay 110 and turbo mode relay 112), although other circuitry may be provided. The main power relay 106 in ON position provides two 110V lines, P1 and P2 to the turbo mode relay 112, and only P1 (110V) to the compressor relay 108. The compressor relay 108 in ON position provides power to the compressor 52 when both the main power relay 106 is also ON. The heat/cool mode relay 110 in ON position activates the solenoid in the 4-way valve 62 to configure the valve from a neutral heating mode to an activated cooling mode. The turbo mode relay 112 in ON position provides 220V power to the electrical resistance heater 90 so as to power on the resistance heater in combination with the heat pump to effect the turbo mode of operation of the temperature control system. The controller 102 signals each of the relays 106, 108, 110, 112 to be in the appropriate position for the selected mode of operation.

TABLE 1
Relays

| Relay | Main | Compressor | Heat/Cool | Turbo | Mode |
|---|---|---|---|---|---|
| Position | OFF | OFF | OFF = Heat | OFF | System Inactive |
| Position | ON | OFF | OFF = Heat | OFF | Power enabled for heat pump |
| | | | or | | heating and cooling modes, but |
| | | | ON = Cool | | neither mode operating; Water |
| | | | | | Temperature at Set Temperature |
| Position | ON | ON | OFF = Heat | OFF | Heat Pump Heating Mode |
| Position | ON | ON | OFF = Heat | ON | Turbo Mode Heating |
| Position | ON | ON | ON = Cool | OFF | Heat Pump Cooling Mode |
| Position | ON | OFF | OFF = Heat | ON | Auxiliary Resistance Heater Only |
| | | | or | | |
| | | | ON = Cool | | |

The system may include a clock timer that is set via the user interface 80 to automatically bring the water to a desired temperature at a set time. Depending on how far in the future is the set time, either the heat pump alone (for more energy efficiency), or the heat pump in combination with the electric heater (i.e., turbo mode) can be used to bring the water to the desired temperature such that it reaches the desired temperature by the set time.

In accord with the above, the clock timer of the control system allows the user to preprogram a time at which the spa water is to reach a specified temperature. The clock timer may be an analog or digital clock that allows the user to program the control system to activate heat pump and/or electric heater (collectively, water temperature modification system) at a specific time on the current day or future date. By way of example, the clock timer can be a digital clock with twelve hour AM and PM settings or a 24 hour clock. Such clock timer can include programming controls similar to an electronic thermostat for setting home environment temperatures; i.e., permitting the user to set a time at which the spa tub water is to be a particular user set temperature, and optionally a day of the week for such settings. The clock timer may include multiday programmability, and the clock timer and user interface may be used to program the control system to activate the water temperature modification system at a regular schedule. As examples, the user can preprogram the control system to activate the water temperature modification system to bring the water to a set temperature every Friday evening at 7 PM or alternatively to activate at regular times on a weekend schedule. In addition, the clock timer may include a user setting or default setting for the length of time for which the water is to be maintained at the set temperature, e.g., one hour.

Alternatively, the clock timer may simply activate the water temperature modification system, e.g., the turbo mode operation, to begin operation at a user set time, as opposed to reach a temperature at a user set time.

In accord with yet another preferred aspect of the invention, the control system includes a memory that stores data related to water temperature and the time required to raise and lower the water to a user input temperature. Additional data may also be stored including mode of operation, ambient temperature, etc. The data is used by the control system to determine the most efficient way to raise or lower the tub water to the temperature set by the user, particularly at the present time.

As the database of information grows, the database becomes more accurate allowing the system to perform more efficiently. The spa tub system references the database each time the user enters a set point for the time and/or day on which the user wants the spa water to reach a particular temperature. Information from the database is then analyzed by the system to determine how far in advance the control system should activate to begin heating or cooling the spa water depending on the water temperature and/or other factors. This allows the control system to activate the heat pump at the optimal time to adjust the temperature to reach the desired temperature at the present time.

The optimal performance time for advance activation may vary depending on the water temperature, ambient temperature, and heater/cooler efficiencies. For example, in mid-summer, the time needed to heat the spa water by ten degrees from a temperature of 90° F. might be three minutes. Therefore, the optimal time determined by reference to the database of the spa system becomes 3 minutes prior to the temperature set point input by the user. However as an example, on a winter day, the optimal time needed to heat the same body of water by twenty degrees from a temperature of 80° F. might be 12 minutes rather than 6 minutes due to the effects of ambient conditions on the spa water. In this example, the optimal time determined by reference to the database of the spa system would be 12 minutes prior to the temperature set point input by the user. The database collects information over time related to time, temperature, and date so that the system improves on the determination of the optimal time with increased use.

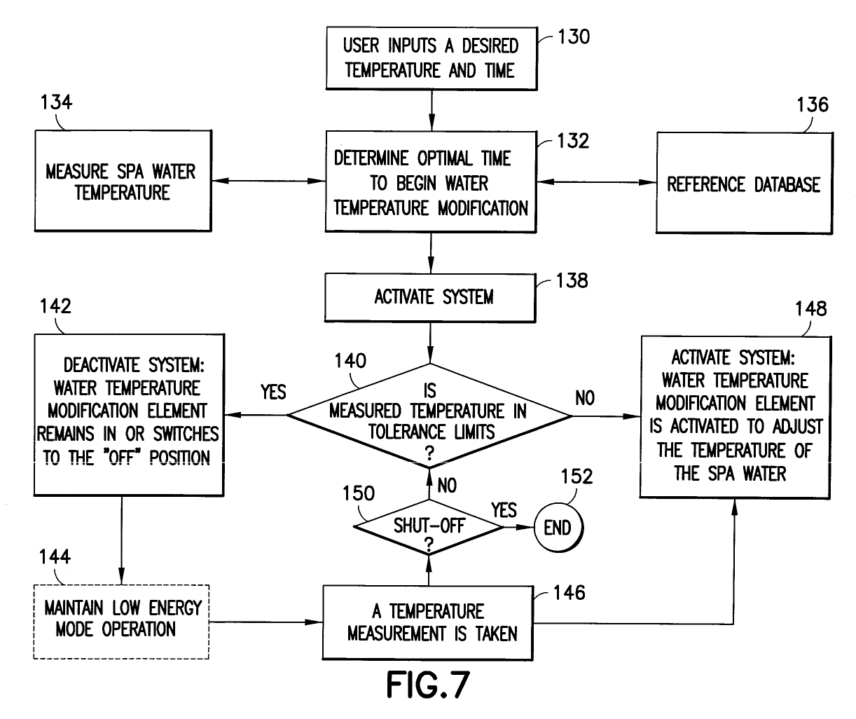

Turning now to FIG. 7, one aspect of the operation of the temperature control is provided. When a user desires the spa water temperature to reach a desired level at a particular time and/or day, the user first sets the clock timer at 130, inputting the user set time and user set temperature into the user interface on the spa system. The control system then determines at 132 the optimal time to begin heating the spa tub water to reach the user set temperature by the user set time. Preferably, the control system activates at a time which provides efficient operation; i.e., bringing the water to the desired temperature at the set time and not in advance so that energy is wasted. This determination is preferably carried out by measuring at 134 the temperature of the tub water at predetermined intervals prior to the user set time and referencing at 136 the database of past performance. If there is in sufficient data in the database from system operations, the database preferably uses preloaded baseline data; i.e., factory defaults, to initially provide efficient operations. Based on the measured temperature and with reference to the database, the control system determines at 132 the optimal time to activate the heat pump (or other water temperature modification system) to reach the user set temperature at the user set time.

Once the system activates at 138, the control system measures the water temperatures at set intervals and determines at 140 whether the measured temperature is between system tolerance limits. These limits are preferably preprogrammed in the control system, but may be optionally set by the user, and are typically between +/−1° F. of the user set temperature. If the measured temperature is within the tolerance limits, the system either (i) deactivates at 142 the heat pump for improved energy performance and re-measures the temperature of the spa water at a system programmed time interval (preferably between 1 millisecond and 1 minute) or (ii) maintains at 144 the heat pump operational in a low energy mode for improved temperature stabilization. Subsequent temperature measurements are taken at 146. If the water temperature is measured to be outside the temperature tolerance limits at 140, the heat pump is activated at 148 to adjust the temperature of the spa water until measured at 140 within the tolerance limits. The heat pump is then deactivated at 142 or placed into a low energy temperature stabilization mode at 144. Additionally, if the water temperature rises higher than the user set temperature (e.g., due to external or environmental factors), it is recognized that the heat pump can be operated in its reverse cooling mode until the water temperature is reduced to within the tolerance limits to further stabilize the temperature. Such temperature stabilization function provides a safety feature to the system. The algorithm continues until a shut-off signal is received at 150 either by manual control or from the clock timer, described above, which terminates at 152 the system temperature regulation. Use of this algorithm by the control system can maintain the spa water temperature at the user set temperature until the control system acts on system shut-off information.

There have been described and illustrated herein several embodiments of a hot tub spa, heating systems therefore, and methods of heating and cooling spas. While particular embodiments of the invention have been described, it is not intended that the invention be limited thereto, as it is intended that the invention be as broad in scope as the art will allow and that the specification be read likewise. Thus, while a particular spa design has been shown and described, it will be appreciated that the heating and cooling system and methods can be applied to other spas as well. Also, the heat pump of the preferred embodiment may be replaced by a number of other water temperature modification systems for heating and cooling spa tub water including gas and oil heaters, electric resistance heaters, and electric coolers to name a few. The system and methods described herein are particularly efficient for larger swim-type spas carrying large amounts of water. It will therefore be appreciated by those skilled in the art that yet other modifications could be made to the provided invention without deviating from its scope as claimed.

What is claimed is:

1. A spa tub system, comprising:
a) a spa tub;
b) a hydrotherapy system including a plurality of jet assemblies mounted within the tub, a suction fitting mounted in the tub, plumbing coupling said jet assemblies, and a water pump that can circulate water from the suction fitting through the plumbing and back into the tub through the jet assemblies under pressure;
c) a water temperature modification system operatively coupled to hydrotherapy system so as to modify the temperature of water flowing through said hydrotherapy system; and
d) a control system for controlling activation of said water temperature modification system, said control system including a clock timer and permitting a user to input a clock time at which the water temperature modification system adjusts the water temperature in the spa to a user set temperature.

2. A spa tub system according to claim 1, wherein:
said control system causes said water temperature modification system to adjust the water temperature to reach the user set temperature by the clock time.

3. A spa tub system according to claim 1, wherein:
said control system causes said water temperature modification system to activate at the clock time.

4. A spa tub system according to claim 1, wherein:
said clock timer has includes multiday programmability.

5. A spa tub system according to claim 1, wherein:
said control system includes a setting for a length of time for which the water is to be maintained at the user set temperature.

6. A spa tub system according to claim 1, wherein:
said water temperature modification system includes a heat pump.

7. A spa tub system according to claim 1, wherein:
said control system uses data from a database to determine a time in advance of said clock time at which to activate said water temperature modification system to adjust said water temperature toward said user set temperature.

8. A spa tub system according to claim 7, wherein:
said database includes historical data related to water temperature and the time required to raise and/or lower the water to a user set temperature.

9. A spa tub system according to claim 7, wherein:
said database includes historical data related to a mode of operation of said water temperature modification system.

10. A spa tub system according to claim 7, wherein:
said database includes historical data related to ambient temperature outside said spa tub water.

11. A control system for a spa tub including a water temperature modification system, said control system comprising:
a) a controller that activates the water temperature modification system;
b) a clock timer coupled to said controller and including a first time; and
c) a user interface allowing input of a user input second time and a user set temperature in relation to the first time on said clock timer, said controller activating the water temperature modification system to adjust the water in the spa to the user set temperature in response to said user input second time.

12. A control system according to claim 11, wherein:
said control system causes said water temperature modification system to adjust the water temperature to reach the user set temperature by the second time.

13. A control system according to claim 11, wherein:
said control system causes activation of said water temperature modification system at said second time.

14. A control system according to claim 11, wherein:
said clock timer has includes multiday programmability.

15. A control system according to claim 11, wherein:
said control system includes a setting for a length of time for which the water is to be maintained at the user set temperature.

16. A control system according to claim 11, further comprising:
a memory including a database of a information to determine a time in advance of said second time at which to activate said water temperature modification system to adjust the water temperature toward the user set temperature.

17. A control system according to claim 16, wherein:
said database includes historical data related to water temperature and the time required to raise and/or lower the water to the user set temperature.

18. A method of operating a spa temperature control system, comprising:
a) providing a control system including a user interface and a clock having a clock time;
b) inputting into the user interface a user set time in relation to the clock time;
c) inputting into the user interface a user set temperature for the spa water; and
d) based upon the input user set time and user set temperature, providing a control signal to adjust the water temperature at a second time.

19. A method according to claim 18, wherein:
said second time is prior to the user set time.

20. A method according to claim 19, wherein:
said second time is selected so that the water temperature is adjusted to the user temperature by the user set time.

21. A method according to claim 18, wherein:
said second time is said user set time.
